(19) United States
(12) Patent Application Publication
(10) Pub. No.: US 2002/0026363 A1
(43) Pub. Date: Feb. 28, 2002

(54) Method and system for implementing remote independent culinary preparation service

(76) Inventor: Harold L. Dunaway, JR., Dallas, TX (US)

Correspondence Address: CARSTENS, YEE & CAHOON, L.L.P., P.O. Box 802334, Dallas, TX, 75380, US

(21) Appl. No.: 09/811,296

(22) Filed: Mar. 16, 2001

Related U.S. Application Data
(60) Provisional application No. 60/190,281, filed on Mar. 17, 2000.

(51) Int. Cl. G06F 17/60

(52) U.S. Cl. 705/15

(57) ABSTRACT

The present invention relates to an online data processing implemented system and method which provides remote culinary preparation services by personal chefs. The delivery of the present system also contains novel business methods. A critical enabler of the present invention is its incorporation of and adaptation to a web based infrastructure common to computer networks such as the Internet. The website centric business model of the present invention greatly enhances a chef's productivity by providing for enhanced and more efficient communications, shopping list preparation, scheduling, and management. Additionally, links to a home grocery delivery service may be included to further enhance the efficiencies of the present invention. In addition to supporting a more efficient business model, the present invention will also provide the marketing necessary to increase consumer awareness of the benefits and affordability of personal chef service. Individual personal chefs simply do not have the time, resources or business skills to fully exploit the industry's growth potential. Moreover, by providing business management tools such as scheduling, payroll and on-line training the system and method of the present invention will enable rapid expansion of the business with low overhead in each individual market.

### RELATED APPLICATIONS

This application claims the benefit, under 35 U.S.C. § 119(e)(1), of U.S. Provisional application Serial No. 60/190,281, filed Mar. 17, 2000, which is incorporated herein by this reference.

### BACKGROUND OF THE INVENTION

1. Technical Field

The present invention relates to information processing technology. More particularly, the present invention relates to an online data processing implemented system and method for providing remote culinary preparation services.

2. Description of the Related Art

American consumers are increasingly spending more of their food purchase dollars on prepared foods, quick serve restaurants, and other convenient meal alternatives. Many new business models are emerging in an attempt to address this growing market opportunity: manufacturers are introducing convenience-based items (e.g., lunch kits and precut vegetables); supermarkets are expanding food service offerings and remodeling to accommodate home meal replacement items; restaurants are adding take-out counters and linking with Internet delivery services; and Internet grocers (e.g., “WEBVAN” and “GROCERYWORKS.COM”) are providing greater convenience in the delivery of grocery items.

While each of these approaches provide valid benefits, none of the aforementioned business models meet consumer needs for convenience, quality and flexibility in the complete fashion of the personal chef. For a modest fee per visit, a client can have a professional chef do their shopping as well as come to their home and prepare a weeks worth of their favorite meals. Not only does this eliminate the time associated with menu planning, shopping and cooking, it also provides high quality food perfectly tailored to the family's tastes and dietary requirements.

According to various industry associations, there are currently over 10,000 active personal chefs in the United States and Canada. These associations provide over 1,000 referrals per month to prospective clients. According to the U.S. Personal Chef Association, ten years ago there were only 1,000 families in the country that used a personal chef. Today, that number has jumped to 100,000 and is expected to grow at increasing rates for the next five to seven years. The personal chef industry is projected to reach over one million households in the next five years.

Despite its rapid growth, the personal chef industry has remained relatively unknown and has captured only a small fraction of consumer's food dollars. The industry is extremely fragmented with individual chefs performing all of the tasks necessary to run their business. Tasks such as marketing, communicating with clients, preparing menus and shopping lists, picking up the needed groceries, paying and collecting bills, balancing check books and filing taxes, can easily occupy as much as 60 percent or more of the chef's time. A need, therefore, exists for an improved and more comprehensive business model to eliminate non-value added activities, freeing the personal chef to focus on his true profession-providing great meals to his customers and servicing additional clients, thereby allowing greater revenue potential from each individual chef.

### SUMMARY OF THE INVENTION

The present invention relates to an online data processing implemented system and method which provides remote culinary preparation services by personal chefs. The delivery of the present system also contains novel business methods. A critical enabler of the present invention is its incorporation of and adaptation to a web based infrastructure common to computer networks such as the Internet. The website centric business model of the present invention greatly enhances a chef's productivity by providing for enhanced and more efficient communications, shopping list preparation, scheduling, and management. Additionally, links to a home grocery delivery service may be included to further enhance the efficiencies of the present invention. In addition to supporting a more efficient business model, the present invention will also provide the marketing necessary to increase consumer awareness of the benefits and affordability of personal chef service. Individual personal chefs simply do not have the time, resources or business skills to fully exploit the industry's growth potential. Moreover, by providing business management tools such as scheduling, payroll and on-line training the system and method of the present invention will enable rapid expansion of the business with low overhead in each individual market.

The website of the present invention is composed of four primary areas each catering to a specific part of the system. The four primary website areas are Visitor, Client, Chef and Manager. Additionally, a corporate site management interface provides for the easy updating of content and graphics.

The Visitor Website Area is designed to provides promotional information useful to potential clients and encourage prospective clients to take advantage of the presented services by subscribing via a convenient online sign-up feature.

The Client Website Area is designed to provide a subscribing client convenient access to a set of features that provide the basic information required to order remote culinary preparation services. The client will also have access to a number of advanced interactive features that will assist them in making selections with more confidence. By providing more information about an item at the time of selection and checking the selection against the client's profile the chance that the client selects a menu item that they will not like is greatly reduced. For example, menu item ratings, relative cost information, ingredient lists, recipe modifications and recommendations all help the client to make a more informed selection and have fun in the process. The website area is also designed to accommodate clients that want to quickly select menus for weeks in advance and clients who enjoy browsing and exploring the menu selections. For the few clients that prefer not to interact with the website, a manager can set their profile for automatic menu selection. Alternatively, a personal chef can manage and operate the client's site with information obtained directly from the client.

The Chef Website Area is designed provide a set of features that help maximize the efficiency of each contracted personal chef and maintain client satisfaction. The Chef area provides to each individual chef detailed information regarding each of their assigned clients. In addition to apprising the chef of a client's particular likes and dislikes, the system also provides numerous database management features which enhance the overall efficiency of each chef. For example, the system includes recipe lists which may include modifications for each particular client, consolidation of grocery lists, and a confirmed inventory of each client's kitchen.

The Manager Website Area is designed to provide convenient access to managers to assist in their oversight of client satisfaction, chef performance, scheduling, accounting, billing and marketing.

It is one general object of the invention to provide an online computer system which distributes promotional information regarding remote culinary preparation services to the general public and allow interested persons to sign-up for such services online.

It is another general object the invention to help clients conveniently select menus that they will consistently enjoy.

It is another general object the invention to provide a greatly expanded list of menu items by making it easy for chefs to add new recipes and to customize each recipe to a plurality of individual clients;

It is another general object the invention to enhance a chef's productivity by providing an online computer system for enhanced and efficient communications with clients, shopping list preparation, scheduling, and management.

It is another general object of the invention to provide metrics for monitoring quality of service and client satisfaction via an online computer system that assists managers in their oversight of client satisfaction, chef performance, scheduling, accounting, billing and marketing.

It is another general object the invention to make the management of a remote culinary preparation service business scaleable and to take advantage of related industry relationships.

It is another general object of the invention to enable rapid expansion of a remote culinary preparation service business by providing an online computer system which incorporates business, marketing and management tools adapted to the remote culinary preparation service.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram depicting a data processing system that may be implemented as a server in accordance with a preferred embodiment of the present invention;

FIG. 3 is a block diagram illustrating a data processing system in which the present invention may be implemented;

FIG. 3 is a block diagram illustrating a data processing system in which the present invention may be implemented;

FIG. 4 is a block diagram illustrating one embodiment of the system of the present invention wherein the sequence of steps illustrate the functionality of the Visitor Website Area;

FIG. 5 illustrates a screen displayed to a user connecting to the Visitor Website Area of the invention over the Internet;

FIG. 6 illustrates the sequence of steps required by a prospective client accessing the service availability and online sign-up feature of the system of the present invention.

FIG. 7 is a block diagram illustrating one embodiment of the system of the present invention wherein the sequence of steps illustrate the functionality of the Client Website Area;

FIG. 8A illustrates the sequence of steps required by a client accessing the recipe search feature of the system of the present invention.

FIG. 8B illustrates a screen displayed to a user utilizing the Recipe Search feature of the invention over the Internet;

FIG. 9A illustrates a screen displayed to a user utilizing the Recipe Search Results feature of the invention over the Internet;

FIG. 9B illustrates a screen displayed to a user utilizing the Menu Organization feature of the invention over the Internet;

FIG. 10 is a block diagram illustrating one embodiment of the system of the present invention wherein the sequence of steps illustrate the functionality of the Chef Website Area; and

FIG. 11 is a block diagram illustrating one embodiment of the system of the present invention wherein the sequence of steps illustrate the functionality of the Manager Website Area.

### DETAILED DESCRIPTION OF THE DRAWINGS

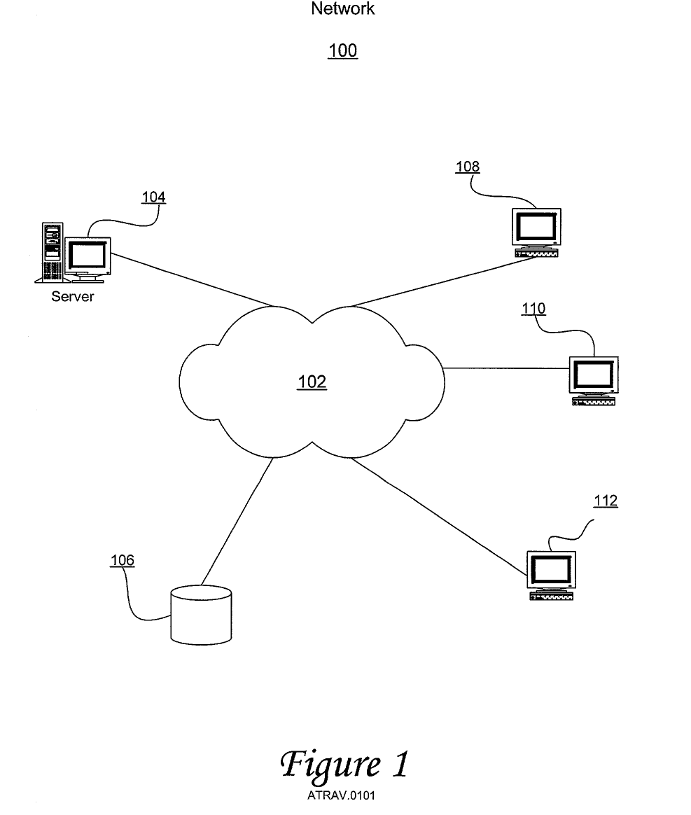

With reference now to the figures, FIG. 1 is a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, a server 104 is connected to network 102 along with storage unit 106. In addition, clients 108, 110 and 112 also are connected to network 102. These clients 108, 110 and 112 may be, for example, personal computers or network computers. For purposes of this application, a network computer is any computer coupled to a network, which receives a program or other application from another computer coupled to the network. In the depicted example, server 104 provides data, such as boot files, operating system images, and applications to clients 108, 110 and 112. Clients 108, 110 and 112 are clients to server 104. Distributed data processing system 100 may include additional servers, clients, and other devices not shown.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, education, and other computer systems that route data and messages. Of course, distributed data processing system 100 also may be implemented as a number of different types of networks, such as, for example, an intranet, a local area network (LAN), or a wide area network (WAN). FIG. 1 is intended as an example and not as an architectural limitation for the present invention.

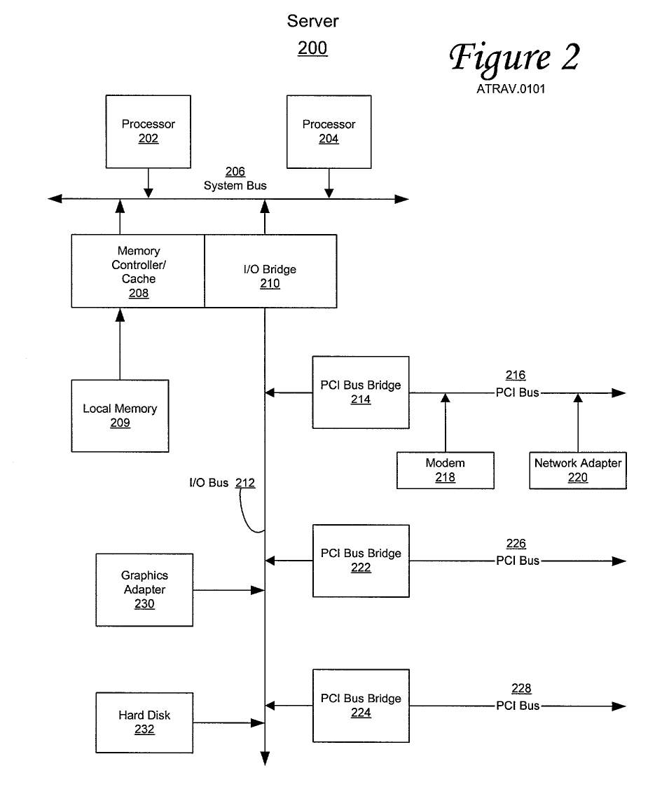

Referring to FIG. 2, a block diagram depicts a data processing system which may be implemented as a server, such as server 104 in FIG. 1, in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI buses 226 and 228, from which additional modems or network adapters may be supported. A memory-mapped graphics adapter 230 and hard disk 232 may also be connected to I/O bus 212 as depicted, either directly or indirectly.

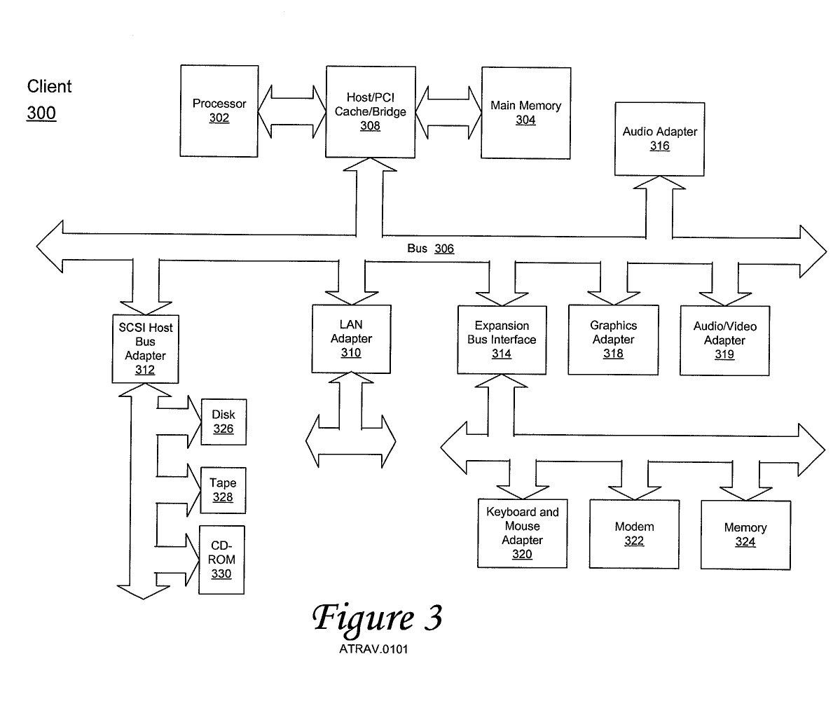

With reference now to FIG. 3, a block diagram illustrates a data processing system in which the present invention may be implemented. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations support three or four PCI expansion slots or add-in connectors.

An operating system runs on processor 302 and is used to coordinate and provide control of various components within data processing system 300 in FIG. 3. The operating system may be a commercially available operating system such as a UNIX based operating system, “AIX” for instance, which is available from International Business Machines Corporation. “AIX” is a trademark of International Business Machines Corporation. Other operating systems include OS/2. An object oriented programming system, such as “JAVA, ” may run in conjunction with the operating system and provide calls to the operating system from Java programs or applications executing on data processing system 300. “JAVA” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

For example, data processing system 300, if optionally configured as a network computer, may not include SCSI host bus adapter 312, hard disk drive 326, tape drive 328, and CD-ROM 330, as noted by dotted line 332 in FIG. 3, denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide nonvolatile memory for storing operating system files and/or user-generated data.

The depicted example in FIG. 3, as well as above-described examples, are not meant to imply architectural limitations.

### The Website

The website is composed of four primary areas each catering to a specific part of the system of the present invention. The four primary website areas are Visitor, Client, Chef and Manager. Additionally, a corporate site management interface provides for the easy updating of content and graphics.

1. Visitor Website Area

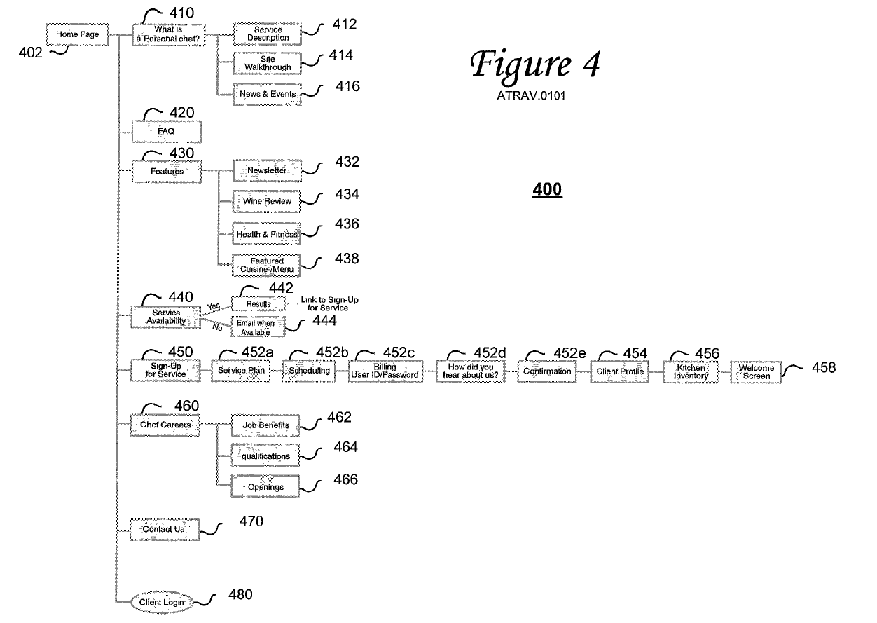

The Visitor Website Area is designed to serve two broad functions: website browsing and online client sign-up. In order to accomplish its browsing function, the Visitor Website Area provides promotional information useful to potential clients. Visitors may access a wide variety of interesting and useful information. For example, as shown in FIG. 4, by accessing the Home Page 402 of the Visitor Website Area 400, visitors may access the Service Description 412 detailing plans and prices which will answer many questions. Wine Reviews and Suggestions 434, Nutrition News 432, Health and Fitness articles/features 438, and Featured Cuisines 438 are also available to be accessed. Reprints of magazine and newspaper articles and online reviews complete with photos and graphics may also be included. This information not only includes food, nutrition and health but also the benefits and features of having a personal chef. A list of frequently asked questions and answers (FAQ) 420 will be provided and updated regularly. Contact information 470 for visitors and clients with additional questions will be prominently displayed. A Walk Though Site Tour 414 will introduce new and prospective clients to the features and menu items available to clients. For existing clients, promotions featuring bonus menu selections for referrals may be included in the Newsletter 432 and on the client's web page. Visitors are free to browse the newsletters and menu selections that are available to clients and review the program and pricing information.

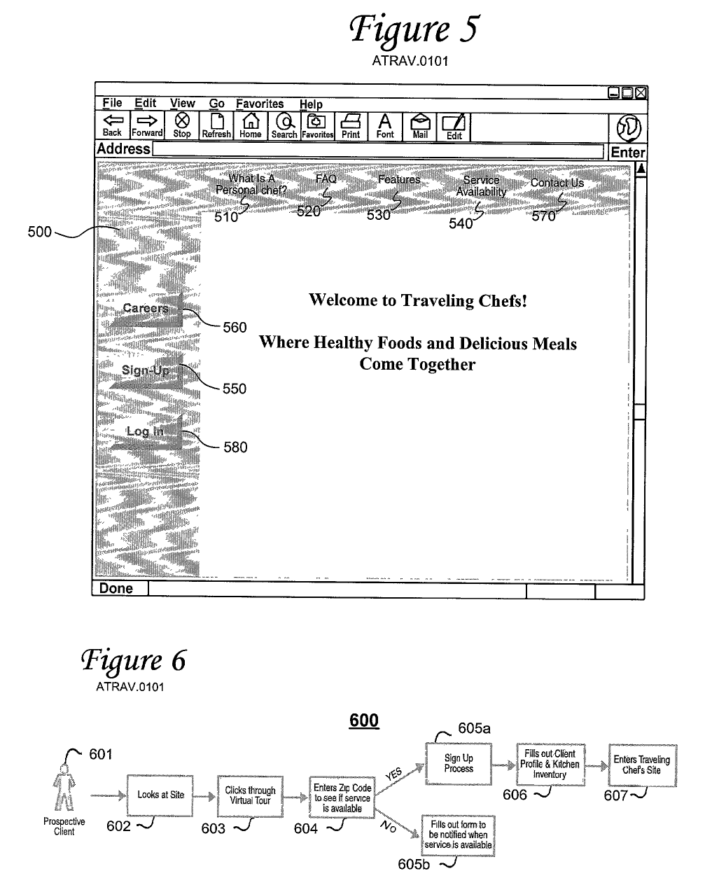

Referring now to both FIGS. 4 and 5, visitors may access the Home Page 402 of the Visitor Website Area 400 of the system of the present invention via the Internet. FIG. 5 illustrates a screen 500 displayed to a user connecting to the Visitor Website Area 400 of the invention over the Internet. In accordance with procedures long practiced in the art and commonly known as “point and click,” visitors to the Home Page 402/500 of the Visitor Website Area 400 may access the various functionalities of the Visitor Website Area 400 by pressing a mouse button pointed to various on-screen “buttons.” By pointing and clicking the on-screen buttons illustrated in FIG. 5, a visitor will access the correlated functionality illustrated in FIG. 4. For example, by pointing and clicking the on-screen button labeled “Careers” 560, a visitor accesses the Chef Careers 460 feature of the Visitor Website Area 400 of the system of the present invention. Similarly, by pointing and clicking the on-screen button labeled “What Is A Personal Chef?” 510, a visitor accesses the What Is A Personal Chef? 410 feature of the Visitor Website Area 400 of the system of the present invention where they may further access the Service Description 412, Site Walkthrough 414, and News & Events 416 features of the Visitor Website Area 400 of the system of the present invention.

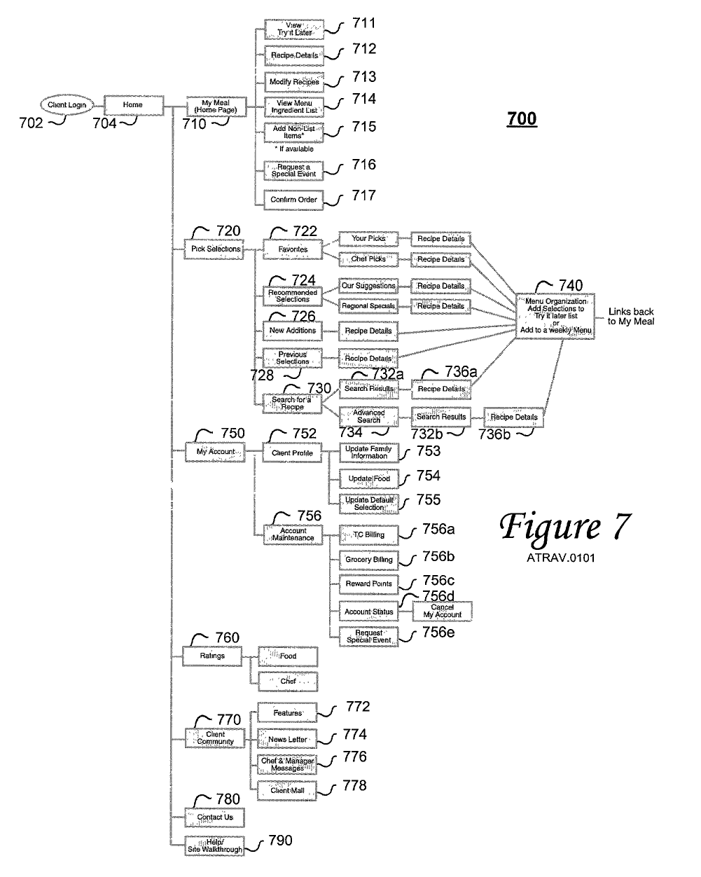

The Visitor Website Area 400 also functions as the entry point for the system's Online Client Sign-Up section 450. Prospective clients browsing the promotional materials included in the Visitor Website Area 400 are encouraged to take advantage of the presented services by subscribing via the convenient Online Sign-Up section 450. The system of the present invention is able to sign-up new clients on a continuous, round the clock basis. As shown in FIG. 6, the system's methodology includes provisions for determining whether service is available in a specific geographic area. Service areas are checked using the client's zip code. A prospective client 601 enters his zip code into the system 604. If services are not currently offered in the client's location the client will asked if they would like to be notified when service is available. Keeping track of requests by area will indicate where additional chefs and managers are needed. If service is confirmed in the client's geographic area, the system redirects the client to the Sign-Up process of the Visitor Website Area 400.

Referring now to FIG. 4, upon accessing the Sign-Up For Service section 450 of the Visitor Website Area 400, the client is directed through choosing a service plan 452a, indicating scheduling preferences 452b, entering billing information and is issued a User/ID Password 452c. Several service plans 452a of varying cost and services provided will be offered. With regard to scheduling preferences 452b, the client will select their preferred day of week and time of day (morning or afternoon) that they would like the chef to come to their home. Clients will be asked for a first, second and third choice of their preferred schedule in case their desired time is not available.

The system will then ask the client a few optional questions regarding how they heard about and why they chose the subject service 452d. Once the client is approved by the system, they are presented with a confirmation screen 452e. This page tells the customer that sign up was successful, provides their user name and login password.

The system then queries the client on a number of topics to initiate the Client Profile 454 feature. hIformation collected via the Client Profile 454 feature is used to better serve the client by providing them with recipes tailored to their personal food preferences and alerting them if they select an item that they are allergic to. The profile contains such information as name, address, phone number, email address, questions about family demographics (i.e., kids age, spouse, etc.), food likes/dislikes, special dietary/medical restrictions, etc.

Finally, the Initial Kitchen Inventory feature 456 is accessed wherein the client provides to the system an inventory of equipment (e.g., appliances the client's kitchen, pots and pans available) and condiments (i.e., spices/oils) available at the client's kitchen. An initial kitchen inventory can be completed during the sign-up process or just prior to the new client's first menu selections The self-inventory relieves the manager from having to visit every client's home prior to first chef's visit. If the client prefers to sign up on the phone or in person, contact information is also available.

2. Client Website Area

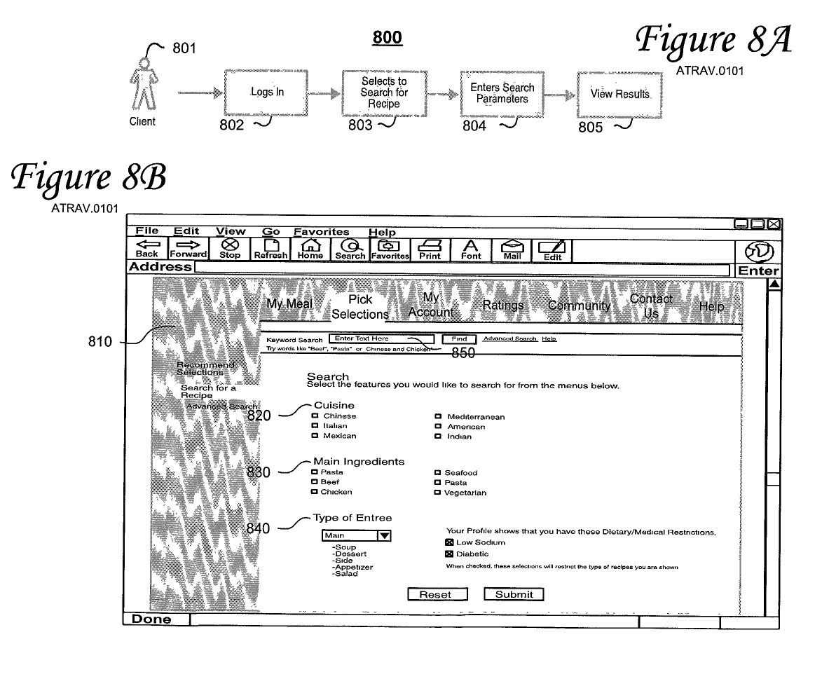

Upon completion of the process entailed in the Sign-Up For Service section 450 of the Visitor Website Area 400, the client is next directed Client Website Area 700, illustrated in FIG. 7. Referring now to FIG. 7, the client accesses the Client Website Area 700 via the Client Login section 702. A previously issued ID and password is utilized by the client in conjunction with the Client Login section 702 to gain access to the Client Website Area 700. Upon gaining access to the Client Website Area 700, a client will have convenient access to a set of basic features which enable the client to interact with the system.

The Client Website Area 700 is also designed to accommodate clients that want to quickly select menus for weeks in advance and clients who enjoy browsing and exploring the menu selections. For the few clients that prefer not to interact with the Client Website Area 700, a manager can set their profile for automatic menu selection. Another alternative is that the chef can manage the Client Website Area 700 with information obtained directly from the client.

After an registered client logs into the Client Website Area 700, the available functions are designed to allow clients to browse available recipes, select meals, and schedule service. The Home section 704 is a personal webpage customized to each individual client's tastes and desires and displays static information content (e.g., the current featured recipes, client's current menu, health reports and fitness stories, the current top ten most popular recipes, referral and bonus program information) and encourages clients to complete their ratings when necessary.

A. My Meal Home Page

The My Meal section 710 displays the client's menu of the week. Menu details such as approximate meal cost, food allergies, low fat icons, items that freeze well icons, time intensive icons, etc. are also displayed. The My Meal section 710 provides access to several advanced interactive features which assist the client in tailoring the system of the present invention to their particular needs. After the client has selected the menu for a chef's visit and it has been checked against the client's profile the client has the option to view the ingredient and price list.

The View Try It Later feature 711 is based on the “wish list” concept, wherein clients may add recipes to the list that they would like to try, but would like to order at a later date. Clients are able to add recipes from this list to their current menu. Clients may also delete/add recipes from this list as well.

The Recipe Detail feature 712 provides a description of the item including main ingredients and nutritional information. The Modify Recipe feature 713 allows the client to make substitutions to the recipe, change portion sizes, and add comments to the chef (i.e. make it very spicy). There are two methods to accommodate modifications to the menu. When viewing information about a specific item, the client can click an onscreen “Change Item” button or if the client wishes to change an item that has already been selected they can click the item to highlight it and then click the onscreen “Change Item” button to make the changes. The “Change Item” button displays a list of standard changes. These changes allow for the addition of meats (e.g., add chicken to the Caesar salad) the substitution of one meat for another (e.g., shrimp for chicken) one cut of meat for another (e.g., filet for flank) as well as portion size increases. Any additional cost associated with preparation will be brought to the client's attention and an approval will be requested. Requests for changes to menu items other than size and primary ingredient can be made in the “Comments to Chef” note available for each item.

By accessing the View Menu Ingredient List feature 714, the client may view a list containing all of the necessary ingredients for this week's menu. Clients can select from this list those items that need to be purchased for the week's menu. The ingredients and their prices are listed for each of the selections. This list gives the client the opportunity to double check for spices or other ingredients that they may not like. For example, chicken could be necessary for one of their entrees. If the client has chicken in their fridge, then it would not be necessary to purchase more chicken. So, the client would not select chicken from the grocery list. This feature will prevent clients from having too much of a particular item. These items would then be delivered by a third party grocery delivery service, if available, and if not, then the chef would purchase these items before they arrived at the home. The list also makes available a “Comments for the Chef” section where comments (e.g., “hold the fennel”) can be added. The prices for the individual ingredients are listed for each menu selection. Totals for each selection are given followed by the grand total for all the selections. The prices are retrieved daily from the grocery service and provided that the list viewing date is close to the actual grocery order date the prices will reflect the exact charges to the client. This ability to check the ingredients and their price offers the client the added security that only the necessary ingredients are charged to their account. It is understood, however, that pricing will only be available where a satisfactory online grocery delivery service exists.

The Add Non-list Items feature 715 allows clients to link to a third party online grocery store and purchase any additional items they need from the store. This feature will clients to take care of all of their grocery needs at one time. It is understood that this feature is only available to clients who have a grocery delivery service in their area.

The Request a Special Event feature 716 allows the client to accommodate vacation and business travel as well as other times that the client will not be able to use the chef's services. Also requests for additional chef visits for special occasions will be made here. The schedule information will be available to the business manager so that they may efficiently schedule the chef's time.

The Confirm Order feature 717 allows a client to submit their order to the system of the present invention. Should the client has fail to confirm the order, the menu is automatically confirmed 48 hours before the scheduled arrival time of their chef. If the client wants to add or delete an item from their menu, they will be directed to Menu Organization feature 740 (discussed below). This structure for the menu interface lays the foundation for more detailed process development. As the interface is defined further, the clients' usability experience will be paramount.

B. Pick Selections

The Pick Selection section 720 provides access to a number of advanced interactive features that enables clients to select with more confidence recipes from the database for a week's requests. By providing more information about the item at the time of selection and checking the selection against the client's profile the chance that the client selects a menu item that they will not like is greatly reduced.

The client will have several lists from which to choose menu selections. For example, the client may choose from previously recorded lists stored under Favorites feature 722, Recommended Selections feature 724, New Additions feature 726, Previous Selections feature 728.

The selections that are chosen are displayed at all times. The selection order can be arranged to suit the client and a brief comment can be added to each selection. While browsing the list of available menu selections the client can click the recipe information link to get a description and ingredients list for that selection. If the client selects more menu items than their meal plan includes then the client is notified and asked for approval of an additional charge. If the additional charge is declined by the client the excess items can be removed. Menu selections can be made in advance for any number of chef's visits. Early selections are encouraged so that shopping can be optimized. Points toward free menu items can be used as a client incentive for early selection. Once the client has settled on their selections they are submitted to the website database and are made available to the chef and management. Changes can be made to the menus up until a specified number of days before the chef's visit. If no selections have been made by the last day then the client's default menu will be ordered.

The Favorites feature 722 contains two lists. The first is a list of menu selections that the client has specifically added to the favorites list as well as menu selections that the client has rated highly. The list is displayed with the client's ratings and comments. The client can add and remove selections at anytime. The second list is the chef's favorites. The client can browse their own chef's list as well as others for selection ideas.

The New Additions feature 726 lists new selections or additions to the recipe database made by the chefs. The list contains the latest recipes approved based on date and quantity, and is updated constantly. Previous new selections lists will be available for browsing.

The Recommendation Selections feature 724 lists menu selections derived from the entire client database. Using selections that the client has rated high and low a database query is made to find other clients that have rated the same selections similarly. This client list is then used to make another database query to find selections rated highly that the client hasn't tried. This list of selections is then compared to the client's profile and the result is presented to the client for possible inclusion in their menu.

Selections may be also be made from selection search results found under Search for a Recipe feature 730. The Search for a Recipe feature 730 allows clients to search the database for a particular recipe or a type of entrée or any set of keywords that are contained in the recipe database. Clients may use a keyword search or use a simple form to search the database. Either search method will present clients with a search results page. The user will then be able to search within those results.

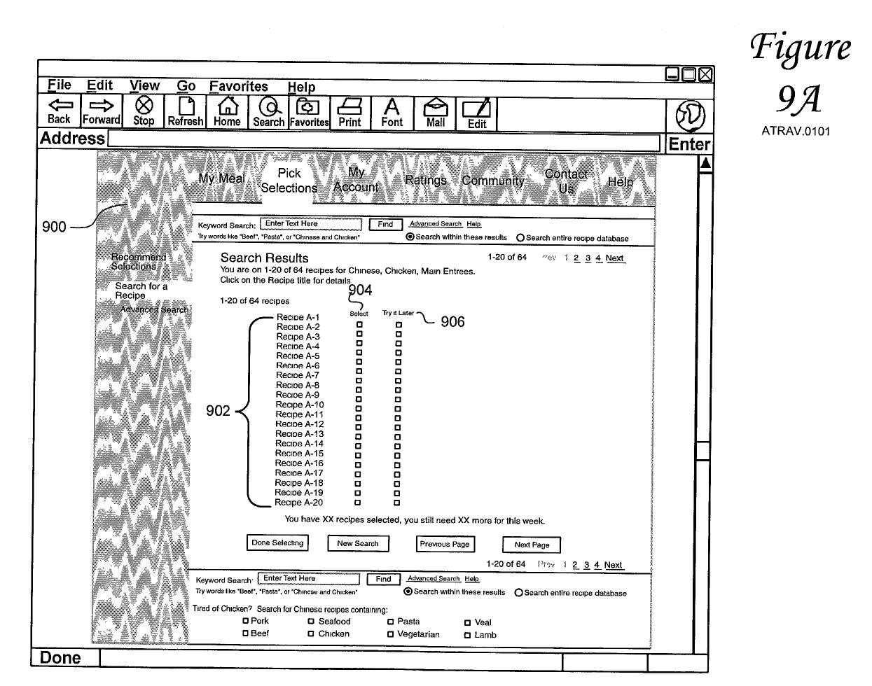

As shown in FIG. 8A, the present invention system's methodology 800 for conducting a search using the Search for a Recipe feature 730 is fairly straight forward. A client 801 enters search parameters 804 and views the results. FIG. 8B illustrates a screen 810 displayed to a client accessing the Search for a Recipe feature 730 to the Client Website Area 700 of the invention over the Internet. Referring now to FIGS. 7, 8A and 8B, the search parameters 804 may include keys which refer to specific attributes of a recipe (e.g., a particular cuisine 820, a specific ingredient 830 , or a specific type 840). Keyword searches 850 and searches based on overall client ratings is also available.

Clients with special diet needs can search for selections that are compatible with specific diets. For example, a client could search for a Chinese dish that contains ginger, is vegetarian, low fat and is cumulatively rated higher than eight. As shown in FIG. 8B, the input of these key to conduct a search are available to the client through simple-to-use user interface objects that require no specific knowledge on the part of the client.

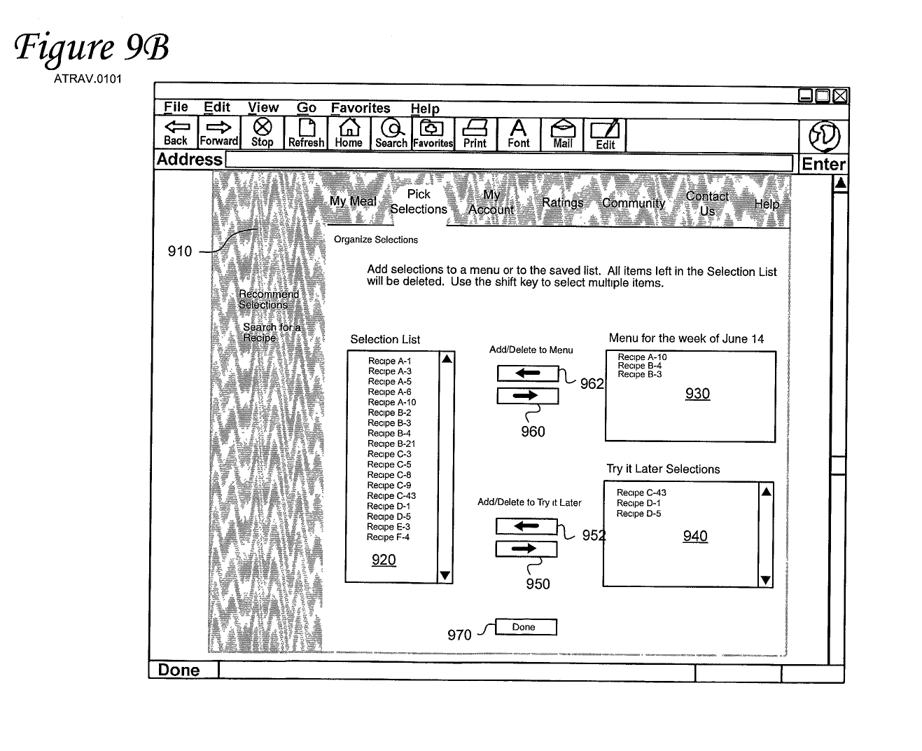

Whichever procedure is used to locate recipes, a clients may subsequently view recipe details. Details for recipes may include nutrition, main ingredients, reheating instructions, freezes well icons, time intensive icons, client ratings, description of the entrée, suggested side dishes & wines, etc. Clients have the option of adding an item to their menu or to their “Try It Later” list. FIG. 9A illustrates a screen 900 displayed to a client viewing the search results page after utilizing the Search for a Recipe feature 730 to the Client Website Area 700 of the invention over the Internet. Upon conducting a search, the system displays recipes 902 in the system's database which meet the search criteria previously entered. FIG. 9A demonstrates the look and feel of any of the recipe selection pages. On all recipe selection pages, the client has the option by utilizing the check boxes in the column labeled “Select” 904 whether the item goes to their current menu or by selecting check boxes in the column labeled “Try It Later” 906 to their “Try it Later” list.

Upon completion of the menu selection process, the system of the present invention advances to a Menu Organization feature 740. Referring now to FIG. 9B, a screen 910 is shown illustrating a display to a client viewing the Menu Organization feature 740 of the invention over the Internet. The screen 910 is intended to allow users who have selected more recipes than what they are normally served in a week to organize their selections. The screen 910 includes a Selection List 920 showing all recipe's selected from previous searches. The client's Current Menu 930 is also displayed. A listing of Try It Later Selections 940 is also displayed. Using simple graphical user interface (GUI) icons 950, 960, a client may select and add recipes on Selection List 920 to either the current menu 930 or the Try It Later Selection 940. Conversely, a client may remove recipes from both the current menu 930 or the Try It Later Selection 940 utilizing the appropriate GUI icons 962, 952. When satisfied with their menu selection, a client points and clicks the onscreen button labeled Done 970 to complete the process.

After the menu selections are made and the ingredients are approved, the ingredient list is compared to the home inventory list. The ingredients and the needed quantities that are expected to be present at the client's home are presented to the client for confirmation. The client can confirm the ingredient's presence or request that it be added to the shopping list.

C. My Account

The My Account section 750 allows the client to access and review billing, account, and profile information contained in the Client Profile feature 752 and the Account Maintenance feature 756. Clients will be encouraged to keep their profile up to date.

The Client Profile feature 752 contains information on the client's likes, dislikes and special goals or needs. For example, food allergies, special dietary needs or diet type, default menus, as well as preferences will be noted in the profile. The client has complete control of the profile and can update its contents at anytime. Any updates to the profile will be included in the Client's Communiqué. The Client's Communiqué is a package of infonnation necessary to prepare all the client's meals for a single chef's visit. The communiqué is made available to the scheduled chef via a single email and also through the “Chef's Message Center” (discussed later). The Client's Communiqué contains client profile information to remind the chef of client preferences such as how spicy they like their food, the menu selections, the composite shopping list and potentially an optimized preparation schedule.

The default menu is a client profile feature that allows the client to specify a menu to be used in the event that the client is unable to log on to the website prior to the chef's visit. Utilizing the Update Default Selection feature 755, the default menu can be changed at any time or with specific client confirmation can be set to either automatic or chef's choice. If the default menu is set to automatic a menu will be randomly selected from the favorites and recommended lists. Single items will not be repeated on consecutive chef's visits. If chef's choice is chosen then the menu will be chosen by the chef from client profile compatible menu selections.

Users will be able to easily update their client profile from My Account section 750 on the website. Clients can modify their name, family demographics, address, phone, medical/dietary restrictions, etc. Clients can also modify their food likes/dislikes. They can change things such as spiciness of food, favorite foods, foods the hate, etc. Every time a client's profile is modified, the information is sent to the Unit Business Manager and to the client's personal chef. This will allow the chef to better serve the client by staying on top of their current diet, nutrition goals, and food preferences.

Utilizing the Account Maintenance feature 756, the client may check and confirm the charges and their dates. Utilizing the TC Billing function 756a, clients can modify what credit card the service is billed to, view previous charges, change the billing address, etc. By using the Grocery Billing function 756b clients can view previous grocery bills and change what credit card it is billed to. It is understood that grocery-billing information will only be available where a satisfactory online grocery delivery service exists. By accessing the Reward Points function 756c clients can view how many reward points they have, see how many more points they need in order to get a free week of service, and get information on how to earn points. By using the Account Status function 756d, clients may cancel service or suspend service for vacations, holidays, etc. Finally, by accessing the Request A Special Event function 756e clients can request a special event from this menu. Special events may include dishes for celebrations (e.g., birthday parties) or dishes to be delivered to others.

D. Ratings

The Ratings section 760 is allows the client to submit ratings on individual chefs as well as individual recipes. Each time the client logs into the system of the present invention they will be greeted with the welcome message of the day and then asked to rate and comment on the menu selections that were prepared for them between now and the last time they logged onto the site. The rating is optional but encouraged. Rating menu selections on preparation, presentation, freshness, taste and adding a brief comment is advantageous to the client for the purpose of future selections. All ratings and comments that the client makes will remain available to that client. Overall averaged ratings base on input from all clients will be presented next to the selection description. These ratings are also utilized by the advanced selection features, which list favorites and recommendations.

E. Client Community

The Client Community section 770 allows clients to access promotional information as well a messages. With the clients permission, they will receive a weekly email newsletter. All clients will be able to read the newsletter in the “Client Message Center.” The newsletter will feature short articles about food and health and also include the weekly feature menu selection. The feature will be chosen based on its newest, high rating or other attributes. Additionally, promotional information on client referral incentives, new chef and manager positions and promotions and new service areas will be included.

Following a chef's visit, there may be information that the chef needs to or would like to communicate to the client (e.g., “you were out of sage so I substituted tyme” or “I really enjoyed cooking for you”). Also at times there may be a need for the manager to communicate to an individual client or a group of clients. These messages will posted to the “Client Message Center” on the website utilizing the Chef and Manager Messages feature 776 and, with the client's permission, emailed to the client. Utilizing the Client Mail feature 778 the client will be able to read, reply or delete the messages as needed from the customer message center. For the client's convenience, the message center will have a “Message to Chef” button for sending messages directly to the client's chef.

F. Contact Us

Contact Us section 780 contains a 1-800/toll free number for customer problems, as well as email/phone numbers for key contacts.

G. Help/Site Walkthrough

Utilizing the Help section 790, assistance will be available to clients at each point in the system in a frequently asked question (FAQ) format.

3. Chef Website Area

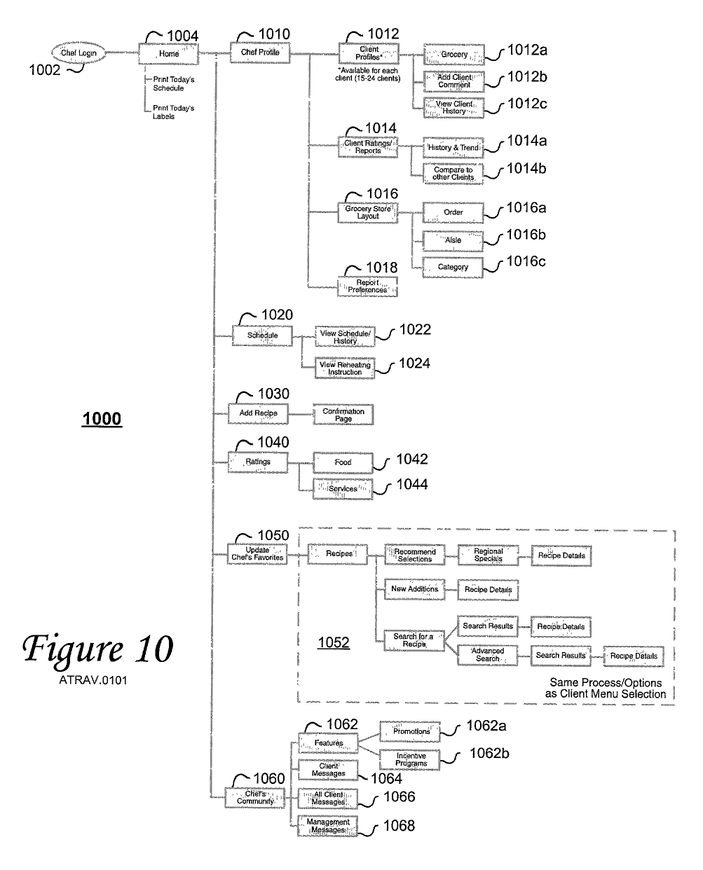

Referring now to FIG. 10, chefs registered under the system of the present invention may access the Chef Website Area 1000 via the Chef Login feature 1002. A previously issued ID and password is utilized by a chef in conjunction with the Chef Login feature 1002 to gain access to the Chef Website Area 1000. Upon gaining access to the Chef Website Area 1000, a chef will have convenient access to a set of basic features which enable the chef to interact with the system and assist the chef in maximizing efficiency and maintaining client satisfaction.

The Chef Login feature 1002 allows a chef to access a personal webpage Home 1004 customized to each individual chef. The chef's Home 1004 provides access to several advanced interactive features which assist the chef in tailoring the system of the present invention to better serve his clients. The chef's Home 1004 includes within its functionality the ability to print the chef's daily schedule and labels. Prior to visiting the client's home, the chef can print the needed preparation labels. These labels are specific to the selected menu items and can be edited by the chef if necessary.

A. Chef Profile

The Chef Profile section 1010 allows a chef to view and administer information regarding assigned clients.

The Client Profiles feature 1012 allows the chef to view the profile information filled out by clients. Each client's profile includes information listed under the following headings: Grocery 1012a-which allows the chef to view whether the client has delivery service or if the chef will do the grocery shopping for that client; Add Client Comment 1012b-which provides the chef with a free form notation area in which the chef can comment on the clients; and View Client History 101 2c-which allows the chef to view a client's detailed profile and ordering history.

The Client Ratings/Reports feature 1014 allow the chef to view his current ratings. One option for this page is to alert the chef to clients who have recently rated him poorly. This encourages the chef to address problems as soon as they occur to ensure client satisfaction. The chef can view two reports on client ratings: History and Trend 1014a-which tracks rating trends over time by individual dimension and all dimensions for all clients or for an individual client; and Compare to Other Clients 1014b-which compare ratings between groups of clients.

The Grocery Store Layout feature 1016 allows the chef to view and enter information on grocery store locations and layouts (i.e., the order in which predefined departments or foods appear in a grocery store according to order 1016a, aisle 1016b, and category 1016c). This feature will enable chefs to sort a client's grocery list according to the store's layout. Where available, a grocery delivery service will be used in order to increase the efficiency of the chef. Automated contents and delivery status information will tract the order and inform the chef if there are any problems. If necessary perishables and non-perishables can be separated and ordered differently while delivery services become available.

The Report Preferences feature 1018 allows the chef to specify preferences for the schedule reports. Some items the chef can customize in the report are page sorting, the detail of the client profile, choosing to not print the grocery list, etc.

B. Schedule

The Schedule section 1020 enables the chef to view their current and past schedule. The schedule is presented by showing clients listed by day and time. A client communiqué is also included. Included in the client's communiqué are the complete recipes for each of the selections. The list is formatted for easy printing or laptop computer display. Optionally a consolidated preparation schedule could be included. This schedule would organize the preparation of all items by task. For example all slicing followed by all sautéing, etc. The chef may print and view the schedule and the reheating labels from this menu. The chef may click on client names to view detailed information about the specific client, including their profile, menu selections, and rating information. As a form of client feedback, the ratings of each menu item are made part of the client's communiqué. This information is used by the chef to get to know their clients better and to make any changes that may help improve future ratings.

Following the client's ratings and menu selections in the client communiqué is the consolidated grocery list. This list will be most important for chefs in areas that require them to do their own shopping. The list will be sorted and merged, meaning that if two selections require four chicken breasts each the list will have a single line specifying eight chicken breasts. The list will also be categorized in the fashion that grocery stores use. Similar item like spices, canned goods and dairy, will all be grouped together. Perishables will be in a separate section so that if necessary one trip to the grocery store for a weeks worth of non-perishables can be followed up with quick efficient daily trips for the fresh ingredients. The shopping lists for multiple clients can be collated to accommodate single grocery visits. Where available high quality online grocery delivery services will be used. Arrangements will be made to price and place orders automatically. Order dates and delivery arrangements will be pre-arranged to assure that the groceries are at the client's house on time.

C. Add Recipe

The Add Recipe section 1030 allows a chef to submit a recipe for consideration by management for inclusion in the website's recipe database. In order for the menu item list to continue to grow, chefs are encouraged to add their favorite recipes and their client's favorite recipes to the database. The Add Recipe section 1030 provides a easy to use tool that will assure that the recipe is properly formatted for the database. If the recipe is compliant with one or more special diets the chef can indicate this during entry. Once a recipe is entered, it is sent to the managers responsible for checking and approving recipes. Approval results in the recipe being added to the database and included in the “New Selections” list. Management releases approved recipes to the website with proper descriptions, preparation instructions, and categorization.

E. Ratings

The Ratings section 1040 enables the chef to rate entrees and the third party food delivery service. Ratings for entrees may include presentation, amount of time, ease of preparation, etc. Ratings for the grocery delivery service may be timeliness, quality of produce, quality of meats, substitution satisfaction, etc.

F. Update Chef's Favorites

The Update Chef's Favorites section 1050 allows the chef to recommend recipes that will then appear on the client's ‘chef-recommended’ list. Each chef will have the ability to add and change the contents of their favorites list. Chefs will be encouraged to update this list frequently. The process 1052 of updating this list will mirror the client menu selection process

G. Chef's Community

The Chef's Community section 1060 allows the chef to stay up-to-date with new corporate programs, unit business manager comments, and client feedback. The Chef's Community section 1060 includes information listed under the following headings: Features 1062-which lists Promotions 1062a (listing various promotional offer) and Programs 1062b (listing performance-based bonuses to chefs); Client Messages 1064-a message board concept wherein chefs will be able to read and respond to messages from their clients in; All Client Messages 1066-a message board concept wherein a chef will be able to read and respond to messages from all existing clients in their unit; and Management Messages 1068-which will allow managers and chefs to communicate with one another concerning a customer complaint, concern, or compliment and common problems or new features.

4. Manager Website Area

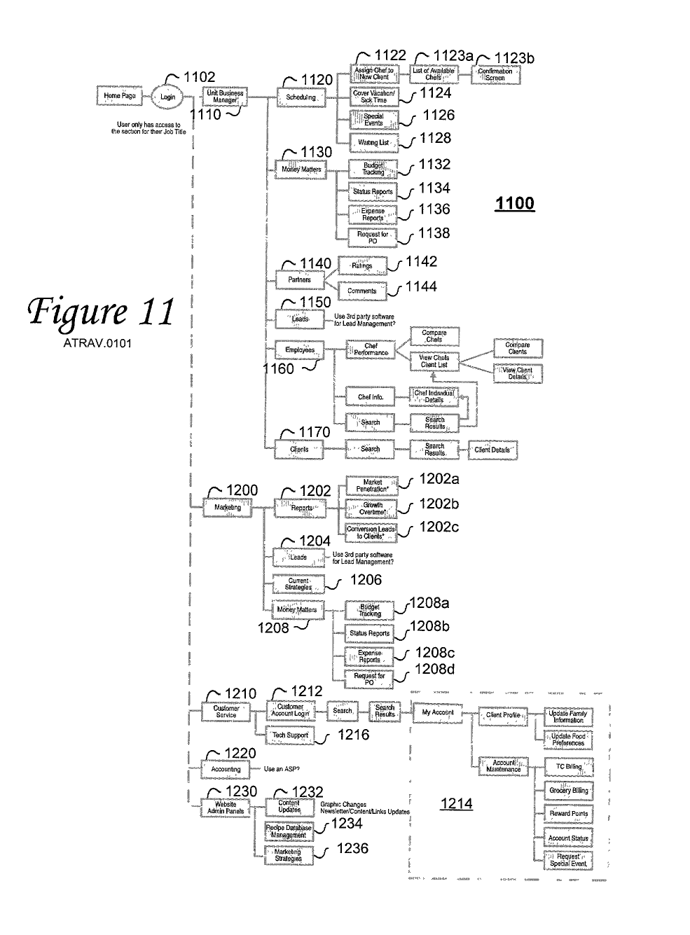

Referring now to FIG. 11, management may use the website for a variety of business and management tasks and reporting. Access to the Management Website Area 1100 via the Login feature 1102. An issued ID and password is utilized by management personnel in conjunction with the Login feature 1102 to gain access to the Management Website Area 1100. The Management Website Area 1100, includes several sections which enable management to interact with the system of the present invention and assists them in their primary tasks. Specific sections include a Unit Business Manager Section 1110, a Marketing Section 1200, a Customer Service Section 1210, an Accounting Section 1220, and a Website Administration Section 1230. Access to the various sections, however, is restricted. Management personnel may access only those sections specifically pertaining to their job title.

A. Unit Business Manager Section

The Unit Business Manager Section 1110 allows a Regional Manager and Unit Business Managers to perform a variety of management functions in a secured website environment.

A Scheduling feature 1120 enables the manager to assign a chef to a new client 1122 (described later). Following that same procedure, the manager can also reschedule clients with a new chef to cover vacations or sick time 1124 and assign chefs to special events 1126. If a client's first choice of time and day is not available (or if there are not any chefs available), the client is placed on a waiting list 1128. When a client cancels their service or makes a request to change their chef, the business manger refers to the waiting list to see if there is a client requesting that time, if there is, the client is sent an email asking if they would like the new time. If the client says yes, than the business manager makes the change and notifies the client as well as the chef. The system of the present invention will also provide the manager with a periodic report indicating the number of client visits for each chef during the period, the scheduled visits for the upcoming period and a projected calendar for the near future. This information is provided to the manager so that the periodic visits as well as special events 1126 can be accommodated.

A Money Matters feature 1130 allows the manager to request a corporate purchase order 1138, file (or approve) an expense report 1136, and produces budget tracking 1132 and operational status reports 1134.

A Partners feature 1140 allows a Regional manager to review third party vendor ratings 1142 and employee comments 1144 about the vendor.

A Leads feature 1150 enables a manager to organize, update and maintain the current leads.

An Employees feature 1160 enables managers to quickly find a particular chef and view their profile. The manager can also view the chef's current client ratings. In a fashion very similar to the monitoring of client satisfaction the chef's performance can be also be monitored. In addition, this section allows for the comparison of chefs according to their rating. A set of automatic statistical reports will indicate relative client satisfaction for each chef Chefs with low ratings can be assisted in problem areas and chefs with high ratings can be recognized. On a search results page, the manager can click on a chef's name to view his entire client list. Also, the manager can compare specific clients, and view an individual client's profile.

A Clients feature 1170 provides keyword search functionality to the system to enable the manager to quickly find a particular client and view their profile. By using the automatic statistical report features the manager can stay informed of relative client satisfaction. Should a client be rating their meals consistently low or if there is a sudden drop the manager will be notified. The client comments then can be looked at to see if they may reveal the problem. By making a personal contact and discussing the issues the manager can solve many problems before they become serious. This regular feed back from the client together with manager interaction will reduce the number of lost clients.

B. Marketing Section

The Marketing Section 1200 allows both corporate and local marketing personnel to perform a variety of management functions in a secured website environment. A Reports feature 1202 enables marketing personnel to interface with the system's databases to generate a variety of marketing management reports. A Leads feature 1204 allows the marketing manager to organize, update and maintain the current leads. A Current Strategies feature 1206 will enable local marketing personnel to stay abreast of the current marketing tactics. Marketing personnel will also have access to current logos, specials and marketing materials. A Money Matters feature 1208 allows the manager to produce budget tracking 1208a and operational status reports 1208b, file (or approve) an expense report 1208c, and request a corporate purchase order 1208d.

C. Customer Service Section

The Customer Service Section 1210 allows customer service representatives to perform a variety of management functions in a secured website environment. A Customer Account Support feature 1212 allows customer service representative to search the client database for a particular client. Once a client's records are found, the customer service representative may access a display interface 1214 essentially identical to the “My Account” section 750 on the Client's Website Area 700. The customer service representative may then modify the client's account record as necessary to correct or modify any information contained therein. A Tech Support feature 1216 serves as a general knowledge base to assist customers having problems using the website.

D. Accounting Section

The Accounting Section 1220 provides for the consolidation of all accounting services online in a secured website environment. With all billable services online, account charges and chef and manager compensation can be centralized. This allows chefs and the field managers more time to concentrate on client satisfaction and new clients. Using automatic credit card charges for client account payment eliminates carrying a large account receivable. Electronic statements delivered to the client's message center will eliminate the processing and mailing costs associated with paper statements. The centralized organization of all grocery and service billing will also add to client convenience.

E. Website Administration Section

A Website Administration Section 1230 provides features which facilitate the maintenance of the website in a secured website environment. A Content Updates feature 1232 allows for the modification of all existing content on the website. Newsletter content consisting of plain text and links may also be updated. A Recipe Database Management feature 1234 allows for the deletion, addition and modification of recipes in the master database. Recipes consist of a name, location for a photograph/image, text to describe it to clients, and text to describe its preparation. Ingredients may be associated with the recipe from a standard (pre-defined) list, along with quantities. Categories pre-defined in the system of the present invention can be associated with the recipe as well to allow category searching. Text keywords may also be associated with the recipe to assist in searching. Finally, a Marketing Strategies feature 1236 will allow file uploads of marketing materials. This feature will be updated through its own admin panel.

### System Methodology Overview

Having now described the primary elements of the system, a review of the system's methodology is in order. As stated previously, a prospective client may access the system of the present invention via a computer network such as the Internet or via an intermediary who will subsequently input the client's information into the system of the present invention. While the methodology will be explained using the former example, it is understood that all procedures may be performed by an intermediary.

Referring to FIGS. 4 and 6, a prospective client 601 enters his zip code into the system 604. If services are not currently offered in the client's location the client will asked if they would like to be notified when service is available. If service is confirmed in the client's geographic area, the system redirects the client to the Sign-Up process of the Visitor Website Area 400. Upon accessing the Sign-Up For Service feature 450 of the Visitor Website Area 400, the client chooses a service plan 452a, indicates scheduling preferences 452b, enters billing information and is issued a User/ID Password 452c. Once the client is approved by the system, the client is presented with a confirmation screen 452e informing the customer that sign up was successful, and providing the client a user name and login password.

Immediately after a new client has signed up for service through the system, their account remains in a pending status until it can be fully activated. Completing the activation of an account may involve: completing profile information; validating billing information; and assigning a chef.

Referring to FIG. 11, the Unit Business Manager assigns a chef to a new client utilizing the Unit Business Manager Section 1110 of the Management Website Area 1100. To complete the chef assignment, the Unit Business Manager logs 1110 in and sees that he has new clients to assign to chefs. The manager selects a client, and views the client's preferences regarding scheduling times (a list of preferred service times is stored with the client's profile). The manager can then begin the process of assigning a chef to this client.

Once a client is selected, the chefs are automatically sorted according to how closely they match the clients requested service time and the geographical area the client lives in. The manager gets a list of available chefs 1123a, and begins the process of assigning a chef. The manger can view the chef's workload, the current schedule he has for that day, the chef's profile, the client's profile, ratings for the chef, etc. Using all of these factors, the manager will select the ‘best fit’ matching a chef's skill level, workload, and existing schedule to the client's needs. Once a match is made, the manager emails the assigned chef and the client utilizing functionalities contain within Confirmation screen 1123b. The assigned chef will receive the client's complete profile for their review and inclusion within the Client Profiles feature 1012 of the assigned chef's Chef Profile section 1010 as illustrated in FIG. 10. Correspondingly, the assigned chef's profile is sent to the client.

Referring now to FIG. 7, to initiate a meal planning process, a client logs on to the system of the present invention via the Client Login feature 702. Upon gaining access to the system, a client views their Home section 704 home page in the Client Website Area 700. The system informs the client of the date of their assigned chef's next visit and how many entrees they still need to select for that visit. If the client is using the automatic selection mode, the system makes note of this. The client then selects recipes from any of the selection lists 722, 724, 726, 728, or through the search process 730.

Regardless of the method used to locate recipes, a client can then view individual recipe details. Referring now to FIGS. 9A and 9B, once a client decides that they want to try a recipe, they have two choices: they can add it to their current menu utilizing the check boxes in the column labeled “Select” 904 or the can add it to their “Try it Later” list by selecting check boxes in the column labeled “Try It Later” 906. While the client is selecting recipes, there will be a reminder that tells them how many recipes they need and how many they have selected. When a client is done selecting, if they have selected too many recipes for the week, they will be directed to a screen 910 which is part of Menu Organization feature 740 of the system.

As illustrated in FIG. 9B, the client may move recipes between the Selection List 920 and Current Menu 930 or between Selection List 920 and Try It Later Selections 940. The client will continue moving items between the three lists, until they have moved everything that they want to keep to either the Current Menu 930 or the “Try It Later Selections 940 list. Any items left in the Selection List 920 will be deleted when the client clicks on the Done 970 button, whereupon the system redirects them to the My Meal section 710 page which displays their menu.

As shown in FIG. 7, utilizing the functionalities contained within the My Meal section 710 of the Client Website Area, the client may modify their menu selection using several options 711, 712, 713, 714, 715, 716. The final step in menu selection process is comprised of actuating the Confirm Order feature 717. Upon actuating the Confirm Order feature 717, information contained in the client's menu selection is sent to the system's database. When confirmed, grocery orders are placed as necessary and the assigned chef is notified. After confirmation, the client may no longer change their menu selections. If the client has not confirmed their menu 48 hours before the arrival of the chef, it will be confirmed automatically.

Referring now to FIG. 10, upon logging into the system of the present invention via the Chef Login feature 1002, chefs may access their daily schedule for a specified date. The schedule is presented by showing clients listed by day and time. The chef may click on client names to view detailed information about the specific client, including their profile, menu selections, and rating information. Client communiqués are included with each client listed. As a form of client feedback, the ratings of each menu item are made part of the client's communiqué. This information is used by the chef to get to know their clients better and to make any changes that may help improve future ratings. The chef may generate a report showing the ingredients required for a given client's service request. If they are grocery shopping for the client, the ingredient list will be sorted according to the physical location of departments in the preferred store. The chef may also print labels on standardized label paper, which provide the serving/reheating instructions for the recipes selected (thus saving time in having to write these instructions by hand to provide to the client).

The process is completed when on the scheduled date and time the assigned chef arrives at the client's home or other specified remote location and prepares the meals in accordance with client's request.

It will now be evident to those skilled in the art that there has been described herein an improved system and method for providing remote culinary preparation services by personal chefs. Although the invention hereof has been described by way of a preferred embodiment, it will be evident that other adaptations and modifications can be employed without departing from the spirit and scope thereof. For example, some of the steps in the system procedure could be conducted mechanically in addition to those conducted electrically. The terms and expressions employed herein have been used as terms of description and not of limitation; and thus, there is no intent of excluding equivalents, but on the contrary it is intended to cover any and all equivalents that may be employed without departing from the spirit and scope of the invention.

What is claimed is:

1. A data processing system implemented method for providing a remote independent culinary preparation service comprising:
(a) receiving a request for culinary preparation service;
(b) allocating a culinary preparation service to a remote location; and
(c) performing the culinary preparation service at the remote location.

2. The data processing system implemented method of claim 1, wherein the system is adapted to a computer network.

3. The data processing system implemented method of claim 1, wherein the culinary preparation service is performed by a personal chef.

4. The data processing system implemented method of claim 1, wherein the request is comprised of:
(i) a menu comprised of at least one recipe;
(ii) a schedule for performing the culinary preparation service at the remote location; and
(ii) a client communiqué.

5. The data processing system implemented method of claim 4, wherein the recipe is selected from a database containing of a plurality of recipes.

6. The data processing system implemented method of claim 5, wherein the recipe is selected from the database using a search method comprising:
(a) selecting at least one search criteria;
(b) searching the database for records containing the search criteria;
(c) viewing a list of recipes from the database matching the search criteria; and
(d) selecting a recipe from the list.

7. The data processing system implemented method of claim 4, wherein the recipe may be modified after being selected.

8. The data processing system implemented method of claim 4, wherein the request further comprises a listing of recipe ingredients.

9. The data processing system implemented method of claim 8, further comprising means for comparing said listing of recipe ingredients against a home inventory list.

10. The data processing system implemented method of claim 8, further comprising means for ordering and delivering to the remote location a food delivery comprised of the listing of recipe ingredients not appearing on the home inventory list.

11. The data processing system implemented method of claim 10, wherein the means for purchasing and delivering comprises using an Internet grocery service.

12. A data processing system implemented method for providing a remote independent culinary preparation service comprising:
(a) receiving a request for culinary preparation service;
(b) selecting a chef to perform a culinary preparation service at a remote location; and
(c) assigning the chef to perform the culinary preparation service at the remote location.

13. The data processing system implemented method of claim 12, wherein the system is adapted to a computer network.

14. The data processing system implemented method of claim 12, wherein the culinary preparation service is performed by a personal chef.

15. A data processing system implemented method for providing a remote independent culinary preparation service comprising:
(a) receiving a schedule comprised of at least one request for culinary preparation service at a remote location; and
(b) performing the culinary preparation service at the remote location.

16. The data processing system implemented method of claim 1, wherein the system is adapted to a computer network.

17. The data processing system implemented method of claim 1, wherein the culinary preparation service is performed by a personal chef.

18. The data processing system implemented method of claim 15, wherein each request is comprised of:
(i) a menu comprised of at least one recipe;
(ii) a client communiqué.

19. The data processing system implemented method of claim 18, wherein the recipe is selected from a database containing of a plurality of recipes.

20. The data processing system implemented method of claim 18, wherein the recipe may be modified after being selected.

21. The data processing system implemented method of claim 18, wherein each request further comprises a listing of recipe ingredients.

22. The data processing system implemented method of claim 18, further comprising means for comparing said listing of recipe ingredients against a home inventory list.

23. The data processing system implemented method of claim 18, further comprising means for ordering and delivering to each remote location a food delivery comprised of recipe ingredients not appearing on the home inventory list.

24. The data processing system implemented method of claim 23, wherein the means for purchasing and delivering comprises using an Internet grocery service.

25. A data processing system for providing remote independent culinary preparation service comprising:
(a) storage means connected to a central processing unit, wherein said storage means is used to store a plurality of data on a storage medium, said plurality comprised of:
(i) a first database for storing client information;
(ii) a second database for storing chef information;
(iii) a third database for storing management information;
(iv) a fourth database for storing general information;
(v) a fifth database for storing recipes;
(b) means for creating and modifying said databases;
(c) means for a client, a chef and a manager to connect to the central processing unit;
(d) a computer program directing the operations of said central processing unit to access said databases and analyze requests received by said client through said connecting means, said computer program further including
(i) means for receiving request for culinary preparation service;
(ii) means for allocating a culinary preparation service; and
(iii) means for directing the chef to perform the culinary preparation
